(19) United States
(12) Patent Application Publication
(10) Pub. No.: US 2025/0167313 A1
(43) Pub. Date: May 22, 2025

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Gyeonggi-do (KR)

(72) Inventors: Soohee KIM, Gyeonggi-do (KR); Changhong KO, Gyeonggi-do (KR); Sam-Jin PARK, Gyeonggi-do (KR); Minjeong LEE, Gyeonggi-do (KR); Jungyoon LEE, Gyeonggi-do (KR); Jinweon SEO, Gyeonggi-do (KR)

(73) Assignee: SAMSUNG SDI CO., LTD., Gyeonggi-do (KR)

(21) Appl. No.: 18/797,175

(22) Filed: Aug. 7, 2024

(30) Foreign Application Priority Data
Nov. 16, 2023 (KR) 10-2023-0159406

(51) Int. Cl. H01M 10/42; H01M 50/42; H01M 50/434; H01M 50/446; H01M 50/449; H01M 50/489

(52) U.S. Cl. CPC H01M 10/4235; H01M 50/42; H01M 50/434; H01M 50/446; H01M 50/449; H01M 50/489

(57) ABSTRACT

Example embodiments include a separator for a rechargeable lithium battery, and a rechargeable lithium battery including the separator. The separator includes a substrate, and a heat resistant adhesive layer on at least one surface of the substrate, wherein the heat resistant adhesive layer includes inorganic particles, a heat resistant binder, and a swellable adhesive binder. The swellable adhesive binder includes a first structural unit derived from a vinyl aromatic monomer, a second structural unit derived from alkyl acrylate, and a third structural unit derived from a phosphonate-based monomer.

### CROSS-REFERENCE TO RELATED APPLICATION

This application claims the benefit of priority from Korean Patent Application No. 10-2023-0159406 filed in the Korean Intellectual Property Office on Nov. 16, 2023, and the entire contents of which are incorporated herein by reference.

### BACKGROUND OF THE INVENTION

### (a) Field of the Invention

Separators for a rechargeable lithium battery and rechargeable lithium batteries including the same are disclosed.

### (b) Description of the Related Art

With the rapid spread of electronic devices that use batteries, such as, e.g., mobile phones, laptop computers, electric vehicles, and the like, there is a large the demand for rechargeable batteries with high energy density and high capacity is rapidly increasing. Accordingly, research and development to improve the performance of rechargeable lithium batteries is advantageous.

A rechargeable lithium battery includes a positive electrode and a negative electrode including an active material capable of intercalating and deintercalating lithium ions, and an electrolyte solution, and electrical energy is produced through oxidation and reduction reactions when lithium ions are intercalated/deintercalated from the positive electrode and the negative electrode.

In order to reduce or prevent short circuits between the positive and negative electrodes of rechargeable lithium batteries, olefin-based substrates are used as separators. The olefin-based substrate has the advantage of desired or improved flexibility, but has disadvantages such as rapid heat shrinkage at high temperatures.

As the capacity and/or output of a rechargeable lithium battery increases, the heat generation amount during charging and discharging increases, and as a result, increasing the heat resistance of the separator may be advantageous. When a rechargeable lithium battery is stored and/or charged and discharged at high temperature, an adhesive force between the separator and the electrode is likely to weaken, and as a result, strengthening the adhesive force between the separator and the electrode may also be advantageous.

### SUMMARY OF THE INVENTION

Some example embodiments provide a separator for a rechargeable lithium battery with desired or improved heat resistance and enhanced adhesive force.

Some example embodiments provide a rechargeable lithium battery including the separator.

Some example embodiments provide a separator for a rechargeable lithium battery including a substrate; and a heat resistant adhesive layer on at least one surface of the substrate, wherein the heat resistant adhesive layer includes inorganic particles, a heat resistant binder, and a swellable adhesive binder, and the swellable adhesive binder includes a first structural unit derived from a vinyl aromatic monomer; a second structural unit derived from alkyl acrylate; and a third structural unit derived from a phosphonate-based monomer.

Some example embodiments provide a rechargeable lithium battery including a positive electrode; a negative electrode; and the separator between the positive electrode and the negative electrode.

The separator according to some example embodiments has desired or improved heat resistance on both surfaces and enhanced adhesive force, and thus can improve high-temperature charge/discharge and/or storage characteristics of a rechargeable lithium battery.

### BRIEF DESCRIPTION OF THE DRAWINGS

FIG. 1 is an exploded perspective view of a rechargeable lithium battery according to some example embodiments.

FIG. 2 is an illustration of a separator for rechargeable lithium battery, according to example embodiments.

### DETAILED DESCRIPTION OF THE EMBODIMENTS

Hereinafter, example embodiments of the present disclosure will be described in detail. However, these embodiments are examples, the present disclosure is not limited thereto and the present disclosure is defined by the scope of claims.

As used herein, when specific definition is not otherwise provided, it will be understood that when an element such as a layer, film, region, or substrate is referred to as being “on” another element, it can be directly on the other element or intervening elements may also be present.

As used herein, when specific definition is not otherwise provided, the singular may also include the plural. In addition, unless otherwise specified, “including A or B” may mean “including A, including B, or including A and B.”

As used herein, “combination thereof” may mean a mixture, a stack, a composite, a copolymer, an alloy, a blend, and a reaction product of constituents.

As used herein, when a definition is not otherwise provided, a particle size may be an average particle size. This average particle size means an average particle size (D50), which is a diameter of particles with a cumulative volume of 50 volume % in the particle size distribution. The average particle size (D50) can be measured by methods well known to those skilled in the art, for example, by measuring with a particle size analyzer, a transmission electron microscope or scanning electron microscope, or a scanning electron microscope. Alternatively, a dynamic light-scattering measurement device is used to perform a data analysis, and the number of particles is counted for each particle size range. From this, the average particle size (D50) value may be easily obtained through a calculation. A laser diffraction method may also be used. When measuring by laser diffraction, more specifically, the particles to be measured are dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle size (D50) based on 50% of the particle size distribution in the measuring device can be calculated.

As used herein, when specific definition is not otherwise provided, “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C7 to C20 arylalkyl group, “alkylene group” refers to a C1 to C20 alkylene group, “arylene group” refers to a C6 to C20 arylene group, “alkylarylene group” refers to a C7 to C20 alkylarylene group, “heteroarylene group” refers to a C3 to C20 heteroarylene group, and “alkoxylene group” refers to a C1 to C20 alkoxylene group.

As used herein, when specific definition is not otherwise provided, “substituted” refers to replacement of at least one hydrogen atom by a substituent that is one of a halogen atom (F, C1, Br, or I), a hydroxy group, a C1 to C20 alkoxy group, a nitro group, a cyano group, an amino group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

As used herein, when specific definition is not otherwise provided, “hetero” refers to inclusion of at least one heteroatom of N, O, S, and P, or other atoms, in chemical formulas.

As used herein, when specific definition is not otherwise provided, “(meth)acrylate” refers to both “acrylate” and “methacrylate,” and “(meth)acrylic acid” refers to “acrylic acid” and “methacrylic acid, and “(meth)acrylamidosulfonic acid” refers to “acrylamidosulfonic acid” and “methacrylamidosulfonic acid.”

In chemical formulas of the present specification, unless a specific definition is otherwise provided, hydrogen is bonded at the position when a chemical bond is not drawn where supposed to be given.

As used herein, a weight average molecular weight (Mw) may be a value measured using gel permeation chromatography (GPC).

When the terms “about” or “substantially” are used in this specification in connection with a numerical value, it is intended that the associated numerical value include a tolerance of +10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%.

### Separator

As rechargeable lithium batteries increase in capacity and/or output, a heat generation amount during charging and discharging increases, and thus improving the heat resistance of the separator may be advantageous.

When a rechargeable lithium battery is stored and/or charged and discharged at high temperature, an adhesive force between the separator and the positive electrode is typically weakened by gas generated from the positive electrode. In addition, lithium salt may precipitate on the surface of the negative electrode by the gas generated from the positive electrode, which tends to weaken the adhesive force between the separator and the negative electrode. As a result, the efficiency of the rechargeable lithium battery may decrease and resistance may increase.

Some example embodiments provide a separator for a rechargeable lithium battery including a substrate; and a heat resistant adhesive layer on at least one surface of the substrate, wherein the heat resistant adhesive layer includes inorganic particles, a heat resistant binder, and a swellable adhesive binder, and the swellable adhesive binder includes a first structural unit derived from a vinyl aromatic monomer; a second structural unit derived from alkyl acrylate; and a third structural unit derived from a phosphonate-based monomer.

Because the separator according to some example embodiments has desired or improved heat resistance and enhanced adhesive force, the high-temperature charging/discharging and/or storage characteristics of a rechargeable lithium battery may be improved.

Hereinafter, the separator according to some example embodiments is described in more detail.

### Properties of Separator

As the separator according to some example embodiments includes the heat resistant adhesive layer, the separator may exhibit the following physical properties.

The separator according to some example embodiments may have a wet adhesive force between the separator and the electrode of greater than or equal to about 0.05 gram-force per millimeter (gf/mm), or greater than or equal to about 0.1 gf/mm, after going through a process under low-temperature and low-pressure conditions.

The separator according to some example embodiments may have a dry shrinkage rate of less than or equal to about 5%, less than or equal to about 4%, less than or equal to about 3%, or less than or equal to about 2.5% at about 150° C.

A separator having the above physical properties can improve the high-temperature charging/discharging and/or storage characteristics of a rechargeable lithium battery.

Heat Resistant Adhesive layer

The heat resistant adhesive layer according to example embodiments may include inorganic particles, a heat resistant binder, and a swellable adhesive binder.

Because the heat resistant binder is a binder with desired, advantageous or improved heat resistance, and the swellable adhesive binder is a binder with desired, advantageous or improved heat resistance and adhesive force, the heat resistant adhesive layer can harmoniously exhibit both heat resistance and adhesive force by one layer.

### Swellable Adhesive Binder

Generally, known binders can mostly or only exhibit wet adhesive force under high-temperature and high-pressure conditions.

However, prismatic rechargeable lithium batteries are manufactured by inserting a jelly roll in which a stack of positive electrode/separator/negative electrode is wound into a prismatic can, and then injecting an electrolyte solution. However, high-temperature and high-pressure conditions cannot be applied during and/or after the manufacturing process. Accordingly, when commonly known binders are applied to prismatic rechargeable lithium batteries, wet adhesive force may not be achieved.

On the other hand, the swellable adhesive binder includes a first structural unit derived from a vinyl aromatic monomer; a second structural unit derived from an alkyl acrylate; and a third structural unit derived from a phosphonate-based monomer, so that wet adhesive force may be achieved even under low-temperature and low-pressure conditions.

Accordingly, the separator according to some example embodiments can achieve wet adhesive force even under low-temperature and low-pressure conditions during the manufacturing process (for example, formation process) of a prismatic rechargeable lithium battery.

The first structural unit derived from the vinyl aromatic monomer may be represented by Chemical Formula 1.

The second structural unit derived from the alkyl acrylate may be represented by Chemical Formula 2.

The third structural unit derived from the phosphonate-based monomer may be represented by Chemical Formula 3.

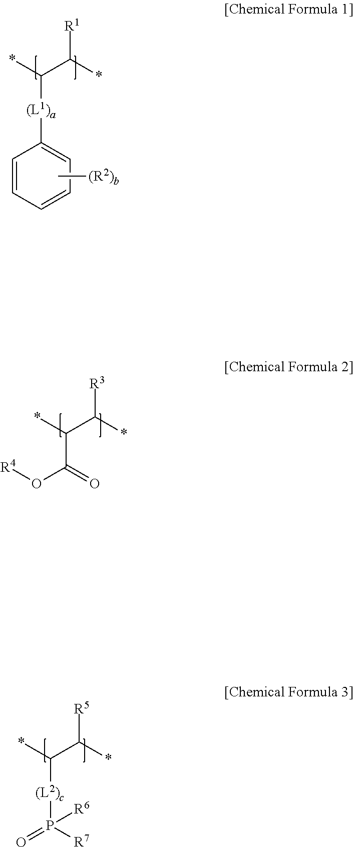

The descriptions of Chemical Formulas 1 to 3 are as follows:

R¹, R³, and R⁵ may each independently be a hydrogen or a C1 to C6 alkyl group. As an example, R¹ may be hydrogen, R³ may be a methyl group, and R⁵ may be a hydrogen or a methyl group.

R² may be fluorine, a substituted or unsubstituted C1 to C6 alkyl group, a substituted or unsubstituted C6 to C20 aryl group, or a substituted or unsubstituted C1 to C6 alkenyl group.

R⁴ may be a substituted or unsubstituted C1 to C20 alkyl group. As an example, R⁴ may be a 2-ethylhexyl group.

L¹ may be a substituted or unsubstituted C1 to C6 alkylene group, a substituted or unsubstituted C3 to C10 cycloalkylene group, a substituted or unsubstituted C6 to C20 arylene group, or a combination thereof.

R² may be a carboxyl group (—C(═O)O—), a carbonyl group (—C(═O)—), an ether group (—O—), a substituted or unsubstituted C1 to C6 alkylene group, a substituted or unsubstituted C3 to C10 cycloalkylene group, a substituted or unsubstituted C6 to C20 arylene group, or a combination thereof. For example, L² may be a carboxyl group (—C(═O)O—).

R⁶ and R⁷ may each independently be a substituted or unsubstituted C1 to C10 alkoxy group, or a substituted or unsubstituted C6 to C20 aryloxy group. For example, R⁶ and R⁷ may all be a methoxy group.

The a and c may each independently be integers of 0 to 2, b may be integers of 0 to 5. As an example, a may be equal to 0, b may be equal to 0, and c may be equal to 1.

Based on 100 wt % of the swellable adhesive binder, the first structural unit may be included in an amount that is greater than or equal to about 40 wt % and less than or equal to about 90 wt %, or about 50 wt % to about 80 wt %; the second structural unit may be included in an amount that is in a range of about 5 wt % to about 40 wt %, or about 10 wt % to about 30 wt %; and the third structural unit may be included in an amount that is about 0.1 wt % to about 20 wt %, or about 5 wt % to about 20 wt %.

The swellable adhesive binder may be in the form of a particle and may maintain the particle form without substantially dissolving in an aqueous solvent.

For example, the swellable adhesive binder may be or include a particle of a core-shell structure, in which case it is advantageous to achieve an appropriate average particle size and an acceptable degree of swelling. Components of the core are not particularly limited and may be or include, for example, an acrylic polymer, a diene polymer, or a copolymer thereof. The shell may include a first structural unit derived from a vinyl aromatic monomer, a second structural unit derived from an alkyl acrylate, and a third structural unit derived from a phosphonate-based monomer.

For example, a D50 particle size of the swellable adhesive binder may be in a range of about 0.1 μm to about 1 μm, about 0.2 μm to about 0.9 μm, about 0.2 μm to about 0.8 μm, or about 0.2 μm to about 0.7 μm. Within this range, the heat resistant adhesive layer can achieve a desired, advantageous or improved adhesive force even at a thin thickness without deteriorating the heat resistance of the separator.

A glass transition temperature of the swellable adhesive binder may be in a range of about 60° C. to about 120° C., about 60° C. to about 90° C., or about 60° C. to about 75° C. Within this range, the swellable adhesive binder is advantageous for exhibiting wet adhesive force even under low-temperature and low-pressure conditions, and the heat resistant adhesive layer can realize desired or improved adhesive force even at a thin thickness without deteriorating the heat resistance of the separator.

After being left in an electrolyte solution at about 60° C. for about 72 hours, the swellable adhesive binder may expand from about 2 times to about 1,000 times, about 3 to about 1,000 times, or about 6 to about 1,000 times its initial volume. Accordingly, the above-discussed acceptable degree of swelling of the swellable adhesive binder is in a range of about 2 times to about 1,000 times, about 3 to about 1,000 times, or about 6 to about 1,000 times the initial volume of the swellable adhesive binder. Within this range, the swellable adhesive binder is advantageous for exhibiting wet adhesive force even under low-temperature and low-pressure conditions, and the heat resistant adhesive layer can realize desired or improved adhesive force even with a small thickness without reducing the heat resistance and air permeability of the separator.

The electrolyte solution composition follows the example.

A weight average molecular weight of the swellable adhesive binder may be in a range of about 100,000 g/mol to about 800,000 g/mol, or about 300,000 g/mol to about 500,000 g/mol as measured by GPC method.

In the heat resistant adhesive layer, a loading amount of the swellable adhesive binder may be about 0.05 to about 1 g/m².

### Heat Resistant Binder

The heat resistant binder may be or include a first heat resistant binder, a second heat resistant binder, or a combination thereof.

The first heat resistant binder may include a fourth structural unit derived (meth)acrylic acid or (meth)acrylate; a fifth cyano group-containing structural unit; and a sixth sulfonate group-containing structural unit.

The fourth structural unit derived from (meth)acrylic acid or (meth)acrylate may be represented by any one of Chemical Formula 11, Chemical Formula 12, Chemical Formula 13, and a combination thereof.

The fifth cyano group-containing structural unit may be represented by Chemical Formula 14.

The sixth sulfonate group-containing structural unit may be represented by any one of Chemical Formula 15, Chemical Formula 16, Chemical Formula 17, and a combination thereof.

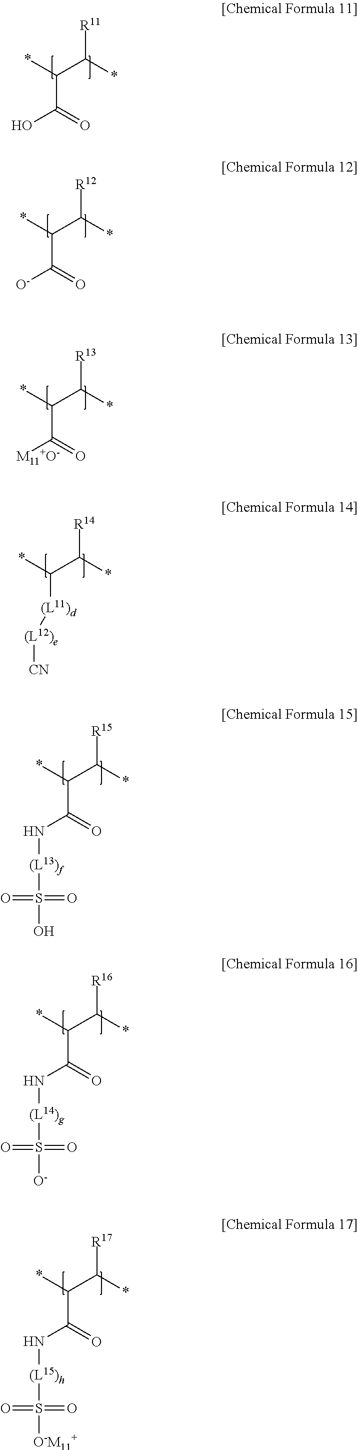

The descriptions of Chemical Formulas 11 to 17 are as follows:

R¹¹ to R¹⁷ may each independently be hydrogen or a C1 to C6 alkyl group. As an example, R¹¹ to R¹⁷ may all be hydrogen.

L¹¹ and L¹² may each independently be a single bond, a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L¹¹ and L¹² may all be a single bond.

L¹³ to L¹⁵ may each independently be a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L¹³ to L¹⁵ may all be *—C(CH₃)₂—CH₂—*.

M₁₁ may be an alkali metal. The alkali metal may be lithium, sodium, potassium, rubidium, or cesium, and for example, may be lithium or sodium.

d, e, f, g, and h may each independently be integers of 0 to 2. For example, d, e, f, g, and h may all be 1.

The fourth structural unit derived from (meth)acrylic acid or (meth)acrylate may include, respectively or together, the structural unit represented by Chemical Formula 11 and the structural unit represented by Chemical Formula 13. In the latter case, the structural unit derived from (meth)acrylic acid or (meth)acrylate may include the structural unit represented by Chemical Formula 11 and the structural unit represented by Chemical Formula 13 in a molar ratio in a range of about 1:10 to about 2:1, about 1:5 to about 1:1, or about 1:3 to about 1:1.

The sixth sulfonate group-containing structural unit may include, respectively or together, the structural unit represented by Chemical Formula 15 and the structural unit represented by Chemical Formula 17. In the latter case, the sixth sulfonate group-containing structural unit may include the structural unit represented by Chemical Formula 15 and a structural unit represented by Chemical Formula 17 in a molar ratio in a range of about 1:10 to about 2:1, about 1:5 to about 1:1, or about 1:3 to about 1:1.

Based on 100 mol % of the first heat resistant binder, the fourth structural unit may be included in an amount of greater than or equal to about 10 mol % to less than or equal to about 70 mol %, greater than or equal to about 30 mol % to less than or equal to about 60 mol %, or greater than or equal to about 40 mol % to less than or equal to about 50 mol %. In other example embodiments, the fifth structural unit may be included in an amount of greater than or equal to about 30 mol % to less than or equal to about 85 mol %, greater than or equal to about 40 mol % to less than or equal to about 70 mol %, or greater than or equal to about 45 mol % to less than or equal to about 55 mol %; and the sixth structural unit may be included in an amount of greater than or equal to about 0.1 mol % to less than or equal to about 20 mol %, greater than or equal to about 0.5 mol % to less than or equal to about 15 mol %, or greater than or equal to about 1 mol % to less than or equal to about 10 mol %.

Examples of the heat resistant binder are as follows:

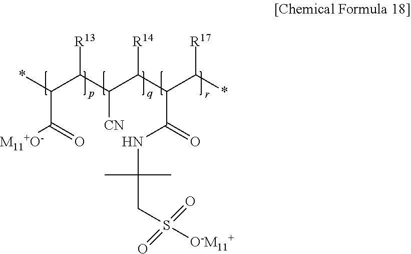

The descriptions of Chemical Formula 18 are as follows.

R¹³, R¹⁴, and R¹⁷ may each independently be hydrogen or a C1 to C6 alkyl group. For example, R¹³, R¹⁴, and R¹⁷ may all be hydrogen.

M₁₁ may be alkali metal. The alkali metal may be lithium, sodium, potassium, rubidium, or cesium, for example lithium or sodium.

The p, q, and r mean a molar ratio of each unit, and may be 0.1≤p≤0.7, 0.3≤q≤0.85, and 0.001≤r≤0.2. Desirably, they may be 0.3≤p≤0.6, 0.4≤q≤0.7, and 0.005≤r≤0.15. More desirably, they may be 0.4≤p≤0.5, 0.45≤q≤0.55, and 0.01≤r≤0.1.

The first heat resistant binder represented by the Chemical Formula 18 may be poly(acrylic acid-co-acrylonitrile-co-lithium 2-acrylamido-2-methylpropanesulfonate salt).

The first heat resistant binder may be prepared by various known methods such as emulsion polymerization, suspension polymerization, massive polymerization, solution polymerization, or bulk polymerization.

The first adhesive binder may have a weight average molecular weight (Mw) in a range of about 200,000 to about 7,000,000 g/mol as measured by GPC method.

The second heat resistant binder may include a seventh structural unit including at least one of a structural unit derived from (meth)acrylic acid or (meth)acrylate and a structural unit derived from (meth)acrylamide; and an eighth structural unit derived from (meth)acrylamidosulfonic acid or a salt thereof.

The structural unit derived from the (meth)acrylic acid or (meth)acrylate may be represented by any one of Chemical Formula 101, Chemical Formula 102, Chemical Formula 103, and a combination thereof.

The structural unit derived from the (meth)acrylamide may be represented by Chemical Formula 104.

The eighth structural unit derived from the (meth)acrylamidosulfonic acid or the salt thereof may be represented by any one of Chemical Formula 105, Chemical Formula 106, Chemical Formula 107, and a combination thereof.

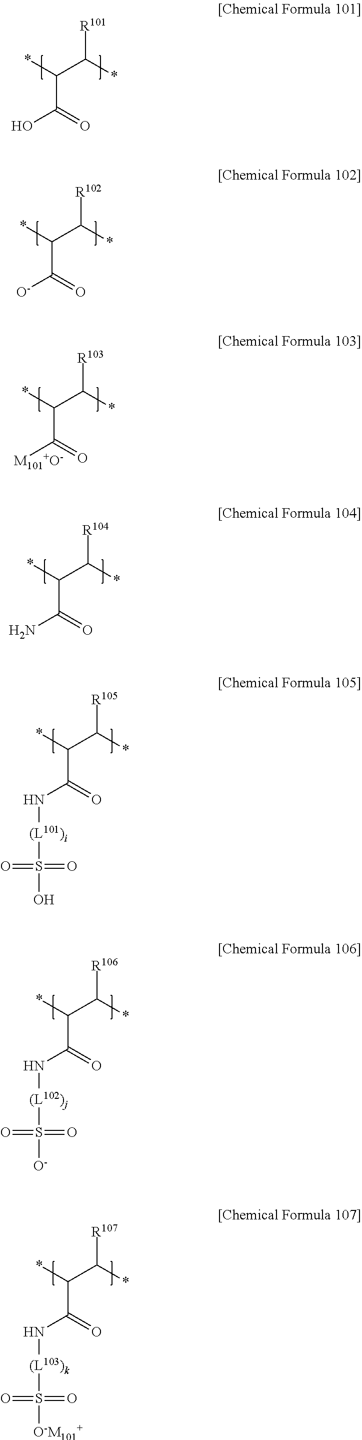

The descriptions of Chemical Formulas 101 to 107 are as follows:

R¹⁰¹ to R¹⁰⁷ may each independently be hydrogen or a C1 to C6 alkyl group. As an example, R¹⁰¹ to R¹⁰⁷ may all be hydrogen.

L¹⁰¹ to L¹⁰³ may each independently be a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L¹⁰¹ to L¹⁰³ may all be *—C(CH₃)₂—CH₂—*.

M₁₀₁ may be an alkali metal. The alkali metal may be lithium, sodium, potassium, rubidium, or cesium, for example lithium or sodium.

i, j, and k may each independently be integers of 0 to 2. As an example, i, j, and k may all be 1.

The structural unit derived from (meth)acrylic acid or (meth)acrylate may include, respectively, or together, the structural unit represented by Chemical Formula 101 and the structural unit represented by Chemical Formula 103. In the latter case, the structural unit derived from the (meth)acrylic acid or (meth)acrylate may include the structural unit represented by Chemical Formula 101 and the structural unit represented by Chemical Formula 103 in a molar ratio in a range of about 1:10 to about 2:1, about 1:5 to about 1:1, or about 1:3 to about 1:1.

The eighth structural unit derived from the (meth)acrylamidosulfonic acid or the salt thereof may include respectively, or together, the structural unit represented by Chemical Formula 105 and the structural unit represented by Chemical Formula 107. In the latter case, the structural unit derived from (meth)acrylamidosulfonic acid or the salt thereof may include the structural unit represented by Chemical Formula 105 and the structural unit represented by Chemical Formula 107 in a molar ratio in a range of about 1:10 to about 2:1, about 1:5 to about 1:1, or about 1:3 to about 1:1.

Based on 100 mol % of the second heat resistant binder, the seventh structural unit may be included in an amount of greater than or equal to about 50 mol % to less than about 100 mol %, or greater than or equal to about 55 mol % to less than about 100 mol %; and the eighth structural unit may be included in an amount of greater than about 0 mol % and less than or equal to about 50 mol % or greater than about 0 mol % and less than or equal to about 45 mol %.

Examples of the second heat resistant binder are as follows:

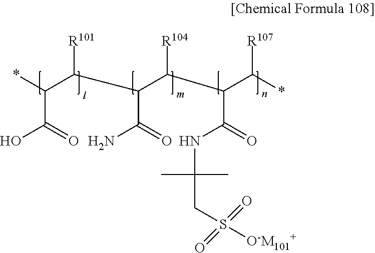

The descriptions of Chemical Formulas 108 is as follows.

R¹⁰¹, R¹⁰⁴, and R¹⁰⁷ may each independently be hydrogen or a C1 to C6 alkyl group. As an example, R¹⁰¹, R¹⁰⁴, and R¹⁰⁷ may all be hydrogen.

M₁₀₁ may be an alkali metal. The alkali metal may be lithium, sodium, potassium, rubidium, or cesium, for example lithium or sodium.

l, m, and n mean a molar ratio of each unit, and l+m+n=1. Herein, 0.5≤(l+m)<1 and 0<n≤0.5, or 0.55≤(l+m)<1 and 0<n≤0.45.

Desirably, 0≤l≤0.4, 0.55≤m≤0.95, and 0<n≤0.1. More desirably, 0≤l≤0.2, 0.8≤m≤0.95, and 0<n≤0.1.

The second heat resistant binder represented by Chemical Formula 108 may be poly(acrylic acid-co-acrylamide-co-lithium 2-acrylamido-2-methylpropanesulfonate salt).

The second heat resistant binder may be prepared by various known methods such as emulsion polymerization, suspension polymerization, bulk polymerization, solution polymerization, or bulk polymerization.

The second heat resistant binder may have a weight average molecular weight in a range of about 350,000 g/mol to about 970,000 g/mol as measured by GPC method.

### Inorganic Particles

The inorganic particles can reduce the possibility of a short circuit between the positive electrode and the negative electrode and hinder or prevent the separator from rapidly shrinking or deforming due to a rise in temperature. That is, the can improve the heat resistance and safety of the battery by including inorganic particles.

The inorganic particles may be Al₂O₃, SiO₂, TiO₂, SnO₂, CeO₂, MgO, NiO, CaO, GaO, ZnO, ZrO₂, Y₂O₃, SrTiOs, BaTiO₃, Mg(OH)₂, boehmite, or a combination thereof.

For example, the inorganic particle may be or include boehmite, which facilitates the control of the D50 particle size and shape.

The D50 particle size of the inorganic particles may be in a range of about 0.1 μm to about 10 μm, about 0.1 μm to about 5 μm, or about 0.1 μm to about 1 μm.

When the inorganic particles are plate-shaped or fibrous, an aspect ratio of the inorganic particles may be in a range of about 1:5 to about 1:100, for example, about 1:10 to about 1:100, or about 1:10 to about 1:50. Additionally, a ratio of the length of the major axis to the minor axis on the flat surface of the plate-shaped inorganic particle may be about 1 to 3 or about 1 to 2. The aspect ratio and the ratio of the length of the major axis to the minor axis may be measured using an optical microscope. When the aspect ratio and the length range of the minor axis to the major axis are satisfied, a heat shrinkage rate of the separator can be lowered, relatively improved porosity can be achieved, and the physical stability of the lithium battery can be improved.

### Composition of Heat Resistant Adhesive Layer

A weight ratio of the swellable adhesive binder and the inorganic particles in the heat resistant adhesive layer may be in a range of about 1:3 to about 1:30, about 1:4 to about 1:25, or about 1:5 to about 1:20. However, the content of the swellable adhesive binder in the heat resistant adhesive layer may be higher on the negative electrode side than on the positive electrode side.

A weight ratio of the heat resistant binder and the swellable adhesive binder in the heat resistant adhesive layer may be in a range of about 1:1 to about 1:10, about 1:1 to about 1:5, or about 1:1 to about 1:3. Within this range, both a high heat resistance and a high adhesive force of the separator according to some example embodiments can be exhibited.

### Thickness of Heat Resistant Adhesive Layer

The thickness of the heat resistant adhesive layer is not particularly limited, but may be about 5 length % to 45 length %, or about 10 length % to 30 length % of the thickness of the substrate, based on the thickness of the heat resistant adhesive layer formed on at least one surface of the porous substrate. For example, a thickness of the heat resistant adhesive layer may be in a range of about 0.1 μm to about 5 μm, or about 0.1 μm to about 3 μm.

### Single-Surface Coating or Double-Surface Coating

The heat resistant adhesive layer may be disposed on at least one surface of the substrate (single-surface coating) or on both surfaces (double-surface coating).

When the heat resistant adhesive layer is coated on both surfaces, it may simultaneously or contemporaneously achieve a higher heat resistance and adhesive force of the separator compared to the case where the heat resistant adhesive layer is coated on only one surface.

### Substrate

The substrate may be or include a porous substrate.

The porous substrate may be or include a polymer film formed of any one of at least a polymer, or a copolymer or mixture of two or more of polyolefin such as polyethylene or polypropylene, a polyester such as polyethyleneterephthalate, or polybutyleneterephthalate, polyacetal, polyamide, polyimide, polycarbonate, polyether ketone, polyaryl ether ketone, polyether imide, polyamideimide, polybenzimidazole, polyether sulfone, polyphenyleneoxide, a cyclic olefin copolymer, polyphenylenesulfide, polyethylenenaphthalate, a glass fiber, TEFLON (tetrafluoroethylene), and polytetrafluoroethylene.

For example, the porous substrate may be or include a polyolefin-based substrate containing polyolefin, and the polyolefin-based substrate may have a desired or improved shutdown function, which can contribute to improving the safety of the battery. The polyolefin-based substrate may be one of, for example, a polyethylene single film, a polypropylene single film, a polyethylene/polypropylene double film, a polypropylene/polyethylene/polypropylene triple film, and a polyethylene/polypropylene/polyethylene triple film. Additionally, the polyolefin-based resin may include a non-olefin resin in addition to an olefin resin, or may include a copolymer of olefin and non-olefin monomer.

The porous substrate may have a thickness in a range of about 1 μm to about 40 μm, for example about 1 μm to about 30 μm, about 1 μm to about 20 μm, about 5 μm to about 20 μm, about 5 μm to about 15 μm, or about 5 μm to about 10 μm.

### Manufacturing Method

The separator for a rechargeable lithium battery according to some example embodiments may be manufactured by various known methods. For example, a separator for a rechargeable lithium battery may be formed by coating a composition for forming a heat resistant adhesive layer on one or both surfaces of a porous substrate, and subsequently drying it.

The coating may be, for example spin coating, dip coating, bar coating, die coating, slit coating, roll coating, inkjet printing, and the like, but is not limited thereto.

The drying may be for example performed through natural drying, drying with warm air, hot air, or low humid air, vacuum-drying, or radiation of a far-infrared ray, an electron beam, and the like, but the present disclosure is not limited thereto. The drying process may be performed at a temperature in a range of, for example, about 25° C. to about 120° C.

The separator for a rechargeable lithium battery may be manufactured by at least one of lamination, coextrusion, and the like in addition to the aforementioned method.

### Rechargeable Lithium Battery

Some example embodiments provide a rechargeable lithium battery including the aforementioned separator.

The separator has desired, advantageous or improved heat resistance and enhanced adhesive force. Accordingly, the rechargeable lithium battery including the separator may have improved high-temperature charge/discharge and/or storage characteristics.

Hereinafter, descriptions that overlap with those described above will be omitted, and a rechargeable lithium battery according to some example embodiments will be described in more detail.

### Positive Electrode Active Material

The positive electrode active material may be or include a compound (e.g., a lithiated intercalation compound) capable of intercalating and deintercalating lithium. Specifically, one or more types of composite oxides of lithium and a metal that is at least one of cobalt, manganese, nickel, and combinations thereof may be used.

The composite oxide may be or include a lithium transition metal composite oxide, and examples may include at least one of lithium nickel-based oxide, lithium cobalt-based oxide, lithium manganese-based oxide, a lithium iron phosphate-based compound, cobalt-free lithium nickel-manganese-based oxide, or a combination thereof.

As an example, a compound represented by any of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0≤α≤2); LiₐNi_{1-b-c}Mn_{b}X_{c}O_{2-α}D_{α} (0.90≤a≤1.8, 0≤b≤0.5, 0≤c≤0.5, 0≤α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a lithium nickel-based oxide represented by Chemical Formula I, a lithium cobalt-based oxide represented by Chemical Formula II, a lithium iron phosphate-based compound represented by Chemical Formula III, a cobalt-free lithium nickel-manganese-based oxide represented by Chemical Formula IV, or a combination thereof.

Liₐ₁ Niₓ₁M¹_{y1}M²_{z1}O_{2-b1}X_{b1} [Chemical Formula I]

In Chemical Formula 1, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² are each independently one or more of Al, B, Ba, Ca, Ce, Co, Cr, Cu, Fe, Mg, Mn, Mo, Nb, Si, Sn, Sr, Ti, V, W, and Zr, and X is one or more of F, P, and S.

In Chemical Formula I, 0.6≤x1≤1, 0≤y1≤0.4, and 0≤z1≤0.4, or 0.8≤x1≤1, 0≤y1≤0.2, and 0≤z1≤0.2.

Liₐ₂Coₓ₂M³₂₂O_{2-b2}X_{b2} [Chemical Formula II]

In Chemical Formula II, 0.9≤a2≤1.8, 0.7≤x2≤1, 0≤y2≤0.3, 0.9≤x2+y2≤1.1, and 0≤b2≤0.1, M³ is one or more of Al, B, Ba, Ca, Ce, Cr, Cu, Fe, Mg, Mn, Mo, Ni, Se, Si, Sn, Sr, Ti, V, W, Y, Zn and Zr, and X is one or more of F, P, and S.

Liₐ₃Feₓ₃M⁴_{y3}PO_{4-b3}X_{b3} [Chemical Formula III]

In Chemical Formula III, 0.9≤a3≤1.8, 0.6≤x3≤1, 0≤y3≤0.4, and 0≤b3≤0.1, M⁴ is one or more of Al, B, Ba, Ca, Ce, Co, Cr, Cu, Mg, Mn, Mo, Ni, Se, Si, Sn, Sr, Ti, V, W, Y, Zn and Zr, and X is one or more of F, P, and S.

Liₐ₄Niₓ₄Mn_{y4}M⁵_{z4}O_{2-b4}X_{b4} [Chemical Formula IV]

In Chemical Formula IV, 0.9≤a2≤1.8, 0.8≤x4<1, 0<y4≤0.2, 0≤z4≤0.2, 0.9≤x4+y4+z4≤1.1, and 0≤b4≤0.1 M⁵ is one or more of Al, B, Ba, Ca, Ce, Cr, Fe, Mg, Mo, Nb, Si, Sn, Sr, Ti, V, W, and Zr, and X is one or more of F, P, and S.

As an example, the positive electrode active material may be or include a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of metals, e.g., metals excluding lithium in the lithium transition metal composite oxide. The high nickel-based positive electrode active materials can achieve high capacity and can be applied to a high-capacity, high-density rechargeable lithium battery.

### Positive Electrode

The example positive electrode for a rechargeable lithium battery may include a current collector and a positive electrode active material layer on the current collector. The positive electrode active material layer may include a positive electrode active material and may further include a binder and/or a conductive material.

For example, the positive electrode may further include an additive configured to operate as a sacrificial positive electrode.

A content of the positive electrode active material may be in a range of about 90 wt % to about 99.5 wt %, and a content of the binder and the conductive material may be in a range of about 0.5 wt % to about 5 wt %, respectively based on 100 wt % of the positive electrode active material layer.

The binder is configured to sufficiently attach the positive electrode active material particles to each other and also to sufficiently attach the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but are not limited thereto.

The conductive material may be used to impart conductivity (e.g., electrical conductivity) to the electrode. Any material that does not cause, e.g., that does not substantially cause, chemical change (e.g., does not cause an undesirable chemical change in the rechargeable lithium battery) and conducts electrons may be used in the battery. Examples of the conductive material may include a carbon-based material such as, e.g., at least one of natural graphite, artificial graphite, carbon black, acetylene black, ketjen black, a carbon fiber, a carbon nanofiber, and carbon nanotube; a metal-based material including at least one of copper, nickel, aluminum, silver, etc., in a form of a metal powder or a metal fiber; a conductive polymer such as a polyphenylene derivative; or a mixture thereof.

The current collector may include Al, but is not limited thereto.

### Negative Electrode Active Material

The negative electrode active material may be or include a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon-based negative electrode active material, for example, crystalline carbon, amorphous carbon or a combination thereof. The crystalline carbon may be graphite such as at least one of non-shaped, plate-shaped, flake-shaped, sphere-shaped, or fiber-shaped natural graphite or artificial graphite. The amorphous carbon may be or include at least one of a soft carbon, a hard carbon, a mesophase pitch carbonization product, calcined coke, and the like.

The lithium metal alloy may include lithium and a metal that is at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x<2), a Si-Q alloy (wherein Q is one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be or include a composite of silicon and amorphous carbon. According to some example embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

### Negative Electrode

A negative electrode for a rechargeable lithium battery includes a current collector and a negative electrode active material layer on the current collector. The negative electrode active material layer includes a negative electrode active material and may further include a binder and/or a conductive material.

For example, the negative electrode active material layer may include a range of about 90 wt % to about 99 wt % of the negative electrode active material, about 0.5 wt % to about 5 wt % of the binder, and about 0.5 wt % to about 5 wt % of the conductive material.

The binder may be configured to sufficiently attach the negative electrode active material particles to each other and also to sufficiently attach the negative electrode active material to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is used as the negative electrode binder, it may further include a cellulose-based compound capable of imparting viscosity. The cellulose-based compound includes one or more of carboxylmethyl cellulose, hydroxypropylmethyl cellulose, methyl cellulose, or alkali metal salts thereof. The alkali metal may be Na, K, or Li.

The dry binder may be or include a polymer material capable of being fiberized, and may be or include, for example, polytetrafluoroethylene, polyvinylidene fluoride, polyvinylidene fluoride-hexafluoropropylene copolymer, polyethylene oxide, or a combination thereof.

The conductive material is included to provide electrode conductivity, and any electrically conductive material may be used as a conductive material unless the electrically conductive material causes a chemical change. Examples of the conductive material may be or include a carbon-based material such as natural graphite, artificial graphite, carbon black, acetylene black, ketjen black, a carbon fiber, a carbon nanofiber, a carbon nanotube, and the like; a metal-based material such as copper, nickel, aluminum silver, and the like in a form of a metal powder or a metal fiber; a conductive polymer such as a polyphenylene derivative; or a mixture thereof.

The negative electrode current collector may include at least one of a copper foil, a nickel foil, a stainless steel foil, a titanium foil, a nickel foam, a copper foam, a polymer substrate coated with a conductive metal, and a combination thereof, but is not limited thereto.

### Electrolyte Solution

The electrolyte solution for a rechargeable lithium battery includes at least one of a non-aqueous organic solvent and a lithium salt.

The non-aqueous organic solvent is configured to be a medium for transmitting ions taking part in the electrochemical reaction of a battery.

The non-aqueous organic solvent may be or include a carbonate-based, ester-based, ether-based, ketone-based, alcohol-based solvent, aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, dimethylacetate, methylpropionate, ethylpropionate, decanolide, mevalonolactone, valerolactone (valerolactone), caprolactone, and the like. The ether-based solvent may include dibutyl ether, tetraglyme, diglyme, dimethoxyethane, 2-methyltetrahydrofuran, 2,5-dimethyltetrahydrofuran, tetrahydrofuran, and the like. The ketone-based solvent may include cyclohexanone. The alcohol-based solvent may include at least one of ethyl alcohol, isopropyl alcohol, and the like, and the aprotic solvent may include nitriles such as R—CN (wherein R is a C2 to C20 linear, branched, or cyclic hydrocarbon group, a double bond, an aromatic ring, or an ether group), amides such as dimethylformamide, dioxolanes such as 1,3-dioxolane or 1,4-dioxolane, sulfolanes, and the like.

The non-aqueous organic solvent may be used alone or in combination of two or more solvents.

Additionally, when using a carbonate-based solvent, cyclic carbonate and chain carbonate can be mixed and used, and cyclic carbonate and chain carbonate may be mixed at a volume ratio in a range of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of a lithium salt may include one or more of LiPF₆, LiBF₄, LiSbF₆, LiAsF₆, LiClO₄, LiAlO₂, LiAlCl₄, LIPO₂F₂, LiCl, LiI, LIN (SO₃C₂F₅)₂, Li(FSO₂)₂N (lithium bis(fluorosulfonyl)imide, LiFSl), LiC₄F₉SO₃, LiN(CₓF₂ₓ₊₁SO₂)(C_{y}F_{2y+1}SO₂) (x and y are integers from 1 to 20), lithium trifluoromethane sulfonate, lithium tetrafluoroethanesulfonate, lithium difluorobis(oxalato)phosphate, (LiDFOB), and lithium bis(oxalato) borate (LiBOB).

### Rechargeable Lithium Battery

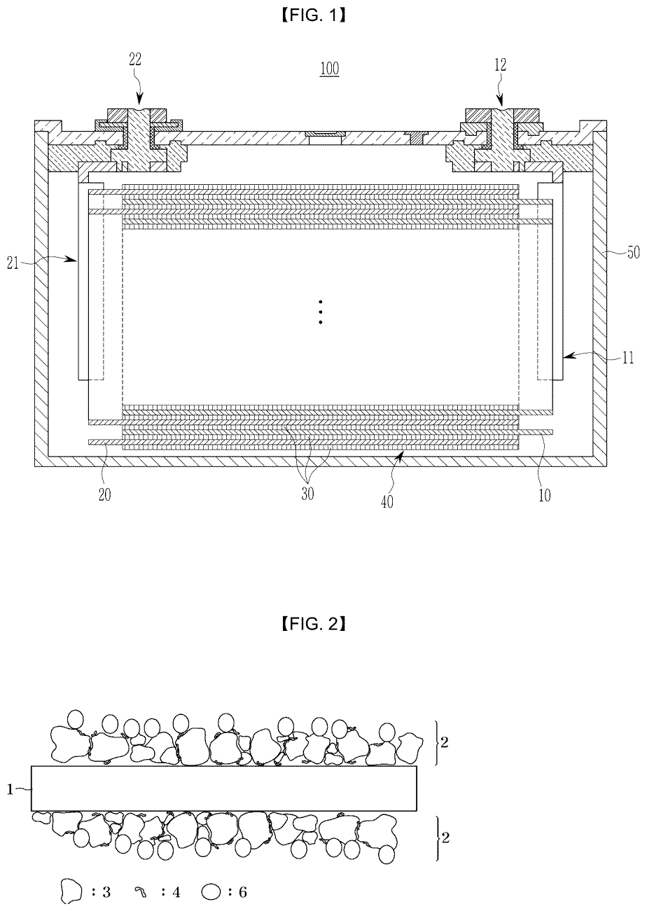

The rechargeable lithium battery may be classified into, e.g., cylindrical, prismatic, pouch, or coin-type batteries, and the like depending on their shape. FIG. 1 is schematic view illustrating a rechargeable lithium battery according to some example embodiments and shows a prismatic battery. Referring to FIG. 1, the rechargeable lithium battery 100 may include an electrode assembly 40 including a separator 30 between a positive electrode 10 and a negative electrode 20, and a case 50 in which the electrode assembly 40 is housed. The positive electrode 10, the negative electrode 20, and the separator 30 may be impregnated with an electrolyte solution (not shown). Additionally, the rechargeable lithium battery 100 may include a positive electrode lead tab 11, a positive electrode terminal 12, a negative electrode lead tab 21, and a negative electrode terminal 22.

FIG. 2 is an illustration of a separator for rechargeable lithium battery, according to example embodiments. In FIG. 2, the separator includes a porous substrate 1, and coating layers 2, which may be or include heat resistant adhesive layers 2, on each side of the separator 1. In various examples, the heat resistant adhesive layer 2 may be on only one side of the separator 1. The heat resistant adhesive layer 2 may include inorganic particles 3, a heat resistant binder 4, and a swellable adhesive binder 5. As discussed above, the swellable adhesive binder 5 may include a first structural unit derived from a vinyl aromatic monomer, a second structural unit derived from alkyl acrylate, and a third structural unit derived from a phosphonate-based monomer.

The rechargeable lithium battery according to some example embodiments may be applied to automobiles, mobile phones, and/or various types of electrical devices, but the present disclosure is not limited thereto. Hereinafter, examples of the present disclosure and comparative examples are described. These examples, however, are not in any sense to be interpreted as limiting the scope of the invention.

### PREPARATION EXAMPLES

### Preparation Example 1

### (1) Preparation of Swellable Adhesive Binder

A swellable adhesive binder with a core-shell structure having a D50 particle size of 0.5 μm, a glass transition temperature of 65° C., a swelling degree of 8 times is prepared.

In the swellable adhesive binder, a core includes a copolymer of alkylacrylate and divinylbenzene, and a shell includes a copolymer of 70 wt % of styrene, 20 wt % of 2-ethylhexylmethacrylate, and 10 wt % of dimethyl[(methacryloxy)methyl]phosphonate.

In addition, “the swelling degree” of the swellable adhesive binder refers to a swelling degree after being allowed to stand in an electrolyte solution at 60° C. for 72 hours relative to an initial volume, wherein the electrolyte solution is a mixed solution of ethyl carbonate (EC)/ethylmethyl carbonate (EMC)/diethyl carbonate (DEC) (in a volume ratio of 3/5/2) including LiPF₆ at a concentration of 1.3 M. Hereinafter, the definition of “the swelling degree” of the swellable adhesive binder is the same as above.

### (2) Preparation of Heat Resistant Binder

The first heat resistant binder, the second heat resistant binder, or a combination thereof may be used as a heat resistant binder, but herein, the second heat resistant binder is used.

A method of manufacturing the second heat resistant binder is as follows.

In a 10 L four-necked flask equipped with a stirrer, a thermometer, and a cooling tube, after adding distilled water (6,361 g), acrylic acid (72.06 g, 1 mol), acrylamide (604.1 g, 8.5 mol), potassium persulfate (2.7 g, 0.01 mol), 2-acrylamido-2-methylpropanesulfonic acid (103.6 g, 0.5 mol), and 5 N lithium hydroxide aqueous solution (1.05 equivalents based on a total amount of 2-acrylamido-2-methylpropanesulfonic acid), the operation of reducing an internal pressure to 10 mmHg with diaphragm pump and returning the internal pressure to normal pressure with nitrogen, is repeated three times.

While controlling the temperature of reaction solution so as to be stable between 65° C. to 70° C., the reaction is conducted for 12 hours. After cooling to room temperature, the pH of the reaction solution is adjusted to 7 to 8 using a 25% aqueous ammonia solution.

The poly(acrylic acid-co-acrylamide-co-lithium 2-acrylamido-2-methylpropanesulfonate salt) is prepared in this manner. Herein, the molar ratio of the structural unit derived from acrylic acid, the structural unit derived from acrylamide, and the structural unit derived from 2-acrylamido-2-methylpropanesulfonic acid is 10:85:5. About 10 mL of the reaction solution (reaction product) is taken and the measurement result of the non-volatile component is 9.5% (theoretical value: 10%).

### (3) Preparation of Composition for Forming Heat Resistant Adhesive Layer

Boehmite with a D50 particle size of 0.3 μm was used as the inorganic particle. A composition for forming a heat resistant adhesive layer was prepared by setting a weight ratio of swellable adhesive binder:inorganic particles to 1:20 and a weight ratio of heat resistant binder:swellable adhesive binder to 3:7.

### Preparation Example 2

A composition for forming a heat resistant adhesive layer was prepared in the same manner as Preparation Example 1, with a difference that the weight ratio of swellable adhesive binder:inorganic particles was changed to 1:16.

### Preparation Example 3

A composition for forming a heat resistant adhesive layer was prepared in the same manner as Preparation Example 1, with a difference that the weight ratio of swellable adhesive binder:inorganic particles was changed to 1:13.

### Preparation Example 4

A composition for forming a heat resistant adhesive layer was prepared in the same manner as Preparation Example 1, with a difference that the weight ratio of swellable adhesive binder:inorganic particles was changed to 1:9.

### Comparative Preparation Example 1

A composition for forming a heat resistant adhesive layer was prepared in the same manner as Preparation Example 1, with a difference that the swellable adhesive binder was not used.

### Comparative Preparation Example 2

### (1) Preparation of Swellable Adhesive Binder

A swellable adhesive binder with a core-shell structure having a D50 particle size of 0.5 μm, a glass transition temperature of 65° C., and a swelling degree of three times is prepared. In the swellable adhesive binder, a core includes a copolymer of alkylacrylate and divinylbenzene, and a shell includes a copolymer of 70 wt % of styrene, 20 wt % of 2-ethylhexylmethacrylate, and 10 wt % of acrylonitrile.

### (2) Preparation of Composition for Forming Heat Resistant Adhesive Layer

A composition for forming a heat resistant adhesive layer was prepared in the same manner as Preparation Example 1, with a difference that the weight ratio of the swellable adhesive binder:inorganic particles was changed to 1:9 while using the swellable adhesive binder.

### Comparative Preparation Example 3

A composition for forming a heat resistant adhesive layer was prepared in the same manner as Comparative Preparation Example 2, with a difference that the weight ratio of swellable adhesive binder:inorganic particles was changed to 1:5.

### Comparative Preparation Example 4

### (1) Preparation of Swellable Adhesive Binder

A swellable adhesive binder with a core-shell structure having a D50 particle size of 0.5 μm, a glass transition temperature of 100° C., and a swelling degree of 5 times is prepared. In the swellable adhesive binder, a core includes a copolymer of alkylacrylate and divinylbenzene, and a shell includes a copolymer of 70 wt % of styrene, 20 wt % of butylacrylate, and 10 wt % of acrylonitrile.

A composition for a heat resistant adhesive layer is prepared in the same manner as in Preparation Example 1, with a difference that the swellable adhesive binder is used.

### (2) Preparation of Composition for Forming Heat Resistant Adhesive Layer

A composition for forming a heat resistant adhesive layer was prepared in the same manner as Preparation Example 1, that the swellable adhesive binder was used.

### Comparative Preparation Example 5

A composition for forming a heat resistant adhesive layer was prepared in the same manner as Comparative Preparation Example 4, with a difference that the weight ratio of swellable adhesive binder:inorganic particles was changed to 1:5.

### Examples and Comparative Examples

### Example 1

### (1) Preparation of Separator

A heat resistant adhesive layer is formed to have a different thickness on both surfaces of a substrate.

Positive electrode side: Specifically, an 8 μm-thick polyethylene film (PE, SK Innovation Co., Ltd.) is used as a substrate, and the composition for a heat resistant adhesive layer according to Preparation Example 1 is coated at 20 m/min is coated in a direct metering method and dried at 60° C. under an (average) absolute aqueous vapor amount of 14 g/m³ to form a heat resistant adhesive layer (a thickness: 2.5 μm) thereon.

Negative electrode side: A heat resistant adhesive layer (thickness: 2.5 μm) was formed on the other surface of the substrate using the same method as above, with a difference that the composition for forming a heat resistant adhesive layer of Preparation Example 4 was used.

The loading amount of the swellable adhesive binder on the surface in contact with each electrode is shown in Table 1. Herein, the loading amount of the swellable adhesive binder may be a value calculated by calculating the weight of the swellable adhesive binder included per unit area of the heat resistant adhesive layer.

### (2) Manufacture of Rechargeable Lithium Battery Cells

LiNi_{0.91}Co_{0.05}Al_{0.04}O₂ as a positive electrode active material, polyvinylidene fluoride as a binder, and carbon as a conductive material were mixed in a weight ratio of 92:4:4, and then, dispersed in N-methyl-2-pyrrolidone to prepare positive electrode slurry. The slurry was coated on a 20 μm-thick Al foil, dried, and compressed to manufacture a positive electrode.

Artificial graphite as a negative electrode active material, a styrene-butadiene rubber as a binder and carboxylmethyl cellulose as a thickener in a weight ratio of 96:2:2 were dispersed in distilled water to prepare negative electrode active material slurry. The slurry was coated on a 15 μm-thick, dried, and compressed to manufacture a negative electrode.

The separator was placed, or sandwiched, between the positive electrode and the negative electrode to form a stack, the stack of the positive electrode, the separator and the negative electrode was wound in the configuration of a “jelly-roll,” the jelly-roll was placed in a prismatic case, and electrolyte solution was injected to manufacture a prismatic battery cell. Herein, the positive electrode side of the separator was in contact with the positive electrode, and the negative electrode side was in contact with the negative electrode.

The electrolyte solution was a mixed solution of ethyl carbonate (EC)/ethylmethyl carbonate (EMC)/diethyl carbonate (DEC) (volume ratio of 3/5/2) including 1.3 M LiPF₆.

### Example 2

A separator and a rechargeable lithium battery cell are manufactured in the same manner as in Example 1 with a difference that the composition for a heat resistant adhesive layer according to Preparation Example 2 is formed to form the positive electrode side of the separator.

### Example 3

A separator and a rechargeable lithium battery cell were manufactured in the same manner as in Example 1, except that the composition for forming a heat resistant adhesive layer of Preparation Example 3 was used when forming the negative electrode side of the separator.

### Example 4

A separator and a rechargeable lithium battery cell were manufactured were manufactured in the same manner as in Example 1, with a difference that the composition for forming a heat resistant adhesive layer of Preparation Example 1 was used when forming the negative electrode side of the separator.

### Comparative Example 1

A separator and a rechargeable lithium battery cell were manufactured in the same manner as in Example 1, with a difference that the composition for forming a heat resistant adhesive layer of Comparative Preparation Example 1 was used when forming the positive electrode side and the negative electrode side of the separator.

### Comparative Example 2

A separator and a rechargeable lithium battery cell were manufactured in the same manner as in Example 1, with a difference that the composition for forming a heat resistant adhesive layer of Comparative Preparation Example 2 was used when forming the positive electrode side of the separator, and the composition for forming a heat resistant adhesive layer of Comparative Preparation Example 3 was used when forming the negative electrode side.

### Comparative Example 3

A separator and a rechargeable lithium battery cell were manufactured in the same manner as in Example 1, with a difference that the composition for forming the heat resistant adhesive layer of Comparative Preparation Example 4 was used when forming the positive electrode side of the separator, and the composition for forming the heat resistant adhesive layer of Comparative Preparation Example 5 was used when forming the negative electrode side.

Each separator of the examples and comparative examples is summarized and shown in Tables 1 and 2.

TABLE 1

| | | | | Heat resistant adhesive | |
|---|---|---|---|---|---|
| | Swellable adhesive binder | | | layer | |
| | | Loading amount (g/m²) | | Thickness (μm) | |
| | | Positive | Negative | Positive | Negative |
| | Composition | electrode | electrode | electrode | electrode |
| | of shell | side | side | side | side |
| Ex. 1 | SM-EHMA- | 0.1 | 0.25 | 2.5 | 2.5 |
| | phosphorus-based | | | | |
| | acryl | | | | |
| Ex. 2 | SM-EHMA- | 0.15 | 0.25 | 2.5 | 2.5 |
| | phosphorus-based | | | | |
| | acryl | | | | |
| Ex. 3 | SM-EHMA- | 0.1 | 0.2 | 2.5 | 2.5 |
| | phosphorus-based | | | | |
| | acryl | | | | |
| Ex. 4 | SM-EHMA- | 0.1 | 0.1 | 2.5 | 2.5 |
| | phosphorus-based | | | | |
| | acryl | | | | |
| Comp. | — | — | — | 2.5 | 2.5 |
| Ex. 1 | | | | | |
| Comp. | SM-EHMA-AN | 0.25 | 0.4 | 2.5 | 2.5 |
| Ex. 2 | | | | | |
| Comp. | SM-BA-AN | 0.1 | 0.4 | 2.5 | 2.5 |
| Ex. 3 | | | | | |

TABLE 2

| | | Heat resistant adhesive layer | | | |
|---|---|---|---|---|---|
| | | | | Swellable adhesive | |
| | | | | binder:inorganic | |
| | | | | particle weight | |
| | | Inorganic | Heat | ratio | |
| | Substrate | particles | resistant | Positive | Negative |
| | Thickness | D50 particle | binder | electrode | electrode |
| | (μm) | size (μm) | Type | side | side |
| Ex. 1 | 8.0 | 0.3 | second heat | 1:20 | 1:9 |
| | | | resistant | | |
| | | | binder | | |
| Ex. 2 | 8.0 | 0.3 | second heat | 1:16 | 1:9 |
| | | | resistant | | |
| | | | binder | | |
| Ex. 3 | 8.0 | 0.3 | second heat | 1:20 | 1:13 |
| | | | resistant | | |
| | | | binder | | |
| Ex. 4 | 8.0 | 0.3 | second heat | 1:20 | 1:20 |
| | | | resistant | | |
| | | | binder | | |
| Comp. | 8.0 | 0.3 | second heat | — | — |
| Ex. 1 | | | resistant | | |
| | | | binder | | |
| Comp. | 8.0 | 0.3 | second heat | 1:9 | 1:5 |
| Ex. 2 | | | resistant | | |
| | | | binder | | |
| Comp. | 8.0 | 0.3 | second heat | 1:20 | 1:5 |
| Ex. 3 | | | resistant | | |
| | | | binder | | |

### Evaluation Examples

Each of the separators and the rechargeable lithium battery cells of the examples and the comparative examples is evaluated, and the results are shown in Tables 3 and 4.

### Evaluation Example 1: Resistance of Separator

Each of the separators of the examples and the comparative examples is manufactured into a 2032 coin-type cell to measure AC impedance, and the results are shown in Table 3.

### Evaluation Example 2: Dry Shrinkage Rate of Separator

After cutting each of the separators of the examples and the comparative examples into a size of 10 cm×10 cm to prepare samples, the samples are allowed to stand at 150° C. for 1 hour in a convection oven to calculate a length variation ratio of a machine direction (MD) and a transverse direction (TD), and the results are shown in Table 3.

### Evaluation Example 3: Wet Adhesive Force Evaluation of Separator (Peeling Test)

### (1) Adhesive Force Between Separator and Positive Electrode

Each of the rechargeable lithium battery cells according to the examples and the comparative examples is maintained at 40° C. under a load of 50 kg for 2 hours. Subsequently, after separating the separator from the positive electrode by about 15 mm away and fixing the separator into an upper grip, while fixing the positive electrode into a lower grip, the separator is elongated in a direction of 180° to peel it at 100 mm/min. Then, a force required for the peeling by 40 mm away is three times measured and then, averaged to obtain an arithmetic mean, and the results are shown in Table 3.

### (2) Adhesive Force Between Separator and Negative Electrode

The same peeling test about the separator and the negative electrode as above also proceeds, and the results are shown in Table 3.

TABLE 3

| | Separator | | | | |
|---|---|---|---|---|---|
| | | | | Wet adhesive force (gf/mm) | |
| | | | | separator- | separator- |
| | Resistance | Dry shrinkage rate (%) | | positive | negative |
| | (Ω) | MD | TD | electrode | electrode |
| Ex. 1 | 0.59 | 2.0 | 2.0 | 0.15 | 0.17 |
| Ex. 2 | 0.61 | 2.5 | 2.0 | 0.20 | 0.17 |
| Ex. 3 | 0.57 | 1.7 | 1.5 | 0.15 | 0.13 |
| Ex. 4 | 0.53 | 1.5 | 1.5 | 0.15 | 0.10 |
| Comp. | 0.48 | 1.3 | 1.5 | 0.02 | 0.02 |
| Ex. 1 | | | | | |
| Comp. | 0.75 | 30.0 | 25.0 | 0.28 | 0.35 |
| Ex. 2 | | | | | |
| Comp. | 0.69 | 25.0 | 20.0 | 0.15 | 0.35 |
| Ex. 3 | | | | | |

### Evaluation Example 4: High-temperature Cycle-life and High-temperature Storage Characteristics of Rechargeable Lithium Battery Cell

### (1) High-Temperature Cycle-Life Characteristics

Each of the rechargeable lithium battery cells of the examples and the comparative examples is charged at 4.25 V at a constant current of 0.1 C and discharged to a cut-off voltage of 3.5 V at a constant current of 0.1 C at 55° C. as initial charge and discharge. Subsequently, the cells are ten times repeatedly charged/discharged within a voltage range of 3.5 V to 4.25 V at 0.5 C.

After the 10 cycles, a battery temperature of the rechargeable lithium battery cells is measured to calculate a temperature increase from the initial temperature, and the results are shown in Table 4. In addition, efficiency is calculated according to Equation 1, and the results are shown in Table 4.

$$Efficiency = ( discharge capacity after 10 cycles / \\ discharge capacity after 1 cycle ) * 100 ( \% ) \qquad [ Equation 1 ]$$

### (2) High-temperature Storage Characteristics

Each of rechargeable lithium battery cells of examples and comparative examples that underwent initial charging and discharging was stored at 60° C., the period (days) from 100% to 80% of SOH (state of health) was confirmed and listed in Table 4.

TABLE 4

| | Rechargeable lithium battery cell | | |
|---|---|---|---|
| | High-temperature cycle- | | |
| | life (55° C., 10 cyc.) | | High-temperature |
| | Temperature | | storage (60° C., |
| | change | Efficiency | SOH80%) |
| | (° C.) | (%) | Day |
| Example 1 | 1.5 | 99 | 360 |
| Example 2 | 1.8 | 99 | 370 |
| Example 3 | 2.0 | 98 | 400 |
| Example 4 | 2.5 | 98 | 400 |
| Comp. | 6.0 | 94 | 240 |
| Ex. 1 | | | |
| Comp. | 2.5 | 96 | 120 |
| Ex. 2 | | | |
| Comp. | 2.7 | 95 | 120 |
| Ex. 3 | | | |

### SUMMARY

In Examples 1 to 4, dry shrinkage rate, wet adhesive force, high-temperature cycle-life, and storage characteristics were improved compared to Comparative Examples 1 to 3.

In detail, the separators of Examples 1 to 4 have a dry shrinkage rate (both MD/TD) of 2.5% or less at 150° C. while reducing or suppressing the increase in resistance at room temperature, and after going through a process under low-temperature and low-pressure conditions, the wet adhesive force between the separator and the electrode was greater than or equal to 0.1 gf/mm.

In addition, the rechargeable lithium battery cells of Examples 1 to 4 ensure high-temperature storage characteristics for more than 360 days, have a temperature change of less than 2.5° C., and have an efficiency of greater than or equal to 98% during high-temperature charging and discharging (cycle-life).

In summary, the separator manufactured according to the examples can simultaneously or contemporaneously achieve heat resistance and adhesive force by providing heat resistance and adhesion properties through a single coating layer. Furthermore, by including the separator for a rechargeable lithium battery, a rechargeable lithium battery with desired, advantageous or improved high-temperature characteristics can be provided.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 1: Porous substrate | 2: Coating layer |
| 3: Inorganic particles | 4: Heat resistant binder |
| 5: Swellable adhesive binder | |

What is claimed is:

1. A separator for a rechargeable lithium battery, the separator comprising:
a substrate; and
a heat resistant adhesive layer on at least one surface of the substrate,
wherein the heat resistant adhesive layer includes:
inorganic particles,
a heat resistant binder, and
a swellable adhesive binder, and
the swellable adhesive binder includes
a first structural unit derived from a vinyl aromatic monomer;
a second structural unit derived from alkyl acrylate; and
a third structural unit derived from a phosphonate-based monomer.

2. The separator as claimed in claim 1, wherein:
in the swellable adhesive binder,
the first structural unit derived from the vinyl aromatic monomer is represented by Chemical Formula 1,
the second structural unit derived from alkyl acrylate is represented by Chemical Formula 2, and
the third structural unit derived from the phosphonate-based monomer is represented by Chemical Formula 3: 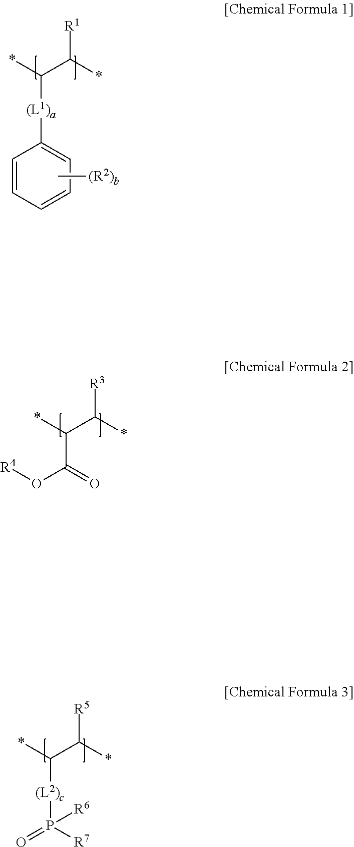
wherein, in Chemical Formulas 1 to 3,
R¹, R³, and R⁵ are each independently hydrogen or a C1 to C6 alkyl group;
R² is fluorine, a substituted or unsubstituted C1 to C6 alkyl group, a substituted or unsubstituted C6 to C20 aryl group, or a substituted or unsubstituted C1 to C6 alkenyl group,
R⁴ is a substituted or unsubstituted C1 to C20 alkyl group,
L¹ is a substituted or unsubstituted C1 to C6 alkylene group, a substituted or unsubstituted C3 to C10 cycloalkylene group, a substituted or unsubstituted C6 to C20 arylene group, or a combination thereof,
L² is a carboxyl group (—C(═O)O—), a carbonyl group (—C(═O)—), an ether group (—O—), a substituted or unsubstituted C1 to C6 alkylene group, a substituted or unsubstituted C3 to C10 cycloalkylene group, a substituted or unsubstituted C6 to C20 arylene group, or a combination thereof,
R⁶ and R⁷ are each independently a substituted or unsubstituted C1 to C10 alkoxy group, or a substituted or unsubstituted C6 to C20 aryloxy group,
a and c are each independently an integer of 0 to 2, and
b is an integer of 0 to 5.

3. The separator as claimed in claim 1, wherein:
the swellable adhesive binder comprises a particle of a core-shell structure, and
the shell comprises a first structural unit derived from a vinyl aromatic monomer, a second structural unit derived from alkyl acrylate, and a third structural unit derived from a phosphonate-based monomer.

4. The separator as claimed in claim 1, wherein:
a D50 particle size of the swellable adhesive binder is in a range of about 0.1 μm to about 1 μm.

5. The separator as claimed in claim 1, wherein:
a glass transition temperature of the swellable adhesive binder is in a range of about 60° C. to about 120° C.

6. The separator as claimed in claim 1, wherein:
after being left in an electrolyte solution at 60° C. for 72 hours, the swellable adhesive binder expands from about 2 time to about 1,000 times.

7. The separator as claimed in claim 1, wherein:
a loading amount of the swellable adhesive binder is in a range of about 0.05 g/m² to about 1 g/m².

8. The separator as claimed in claim 1, wherein:
the heat resistant binder comprises at least one of a first heat resistant binder, a second heat resistant binder, and a combination thereof, and
the first heat resistant binder comprises:
a fourth structural unit derived (meth)acrylic acid or (meth)acrylate;
a fifth cyano group-containing structural unit; and
a sixth sulfonate group-containing structural unit, and
the second heat resistant binder includes:
a seventh structural unit including at least one of a structural unit derived from (meth)acrylic acid or (meth)acrylate and a structural unit derived from (meth)acrylamide; and
an eighth structural unit derived from (meth)acrylamidosulfonic acid or a salt thereof.

9. The separator as claimed in claim 8, wherein:
the fourth structural unit derived from (meth)acrylic acid or (meth)acrylate is represented by any one of Chemical Formula 11, Chemical Formula 12, Chemical Formula 13, and a combination thereof,
the fifth cyano group-containing structural unit is represented by Chemical Formula 14, and
the sixth sulfonate group-containing structural unit is represented by any one of Chemical Formula 15, Chemical Formula 16, Chemical Formula 17, and a combination thereof: 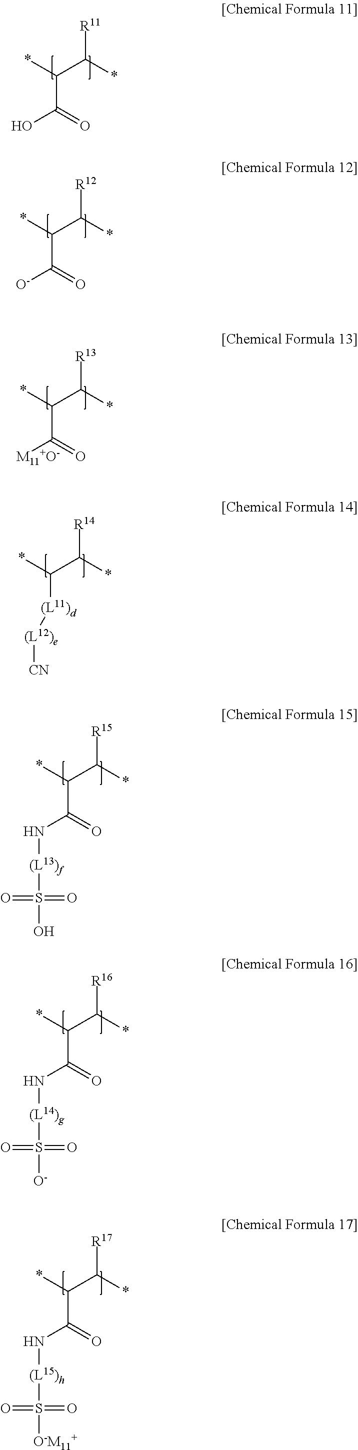
wherein, in Chemical Formulas 11 to 17,
R¹¹ to R¹⁷ are each independently hydrogen or a C1 to C6 alkyl group;
L¹¹ and L¹² are each independently a single bond, a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
L¹³ to L¹⁵ are each independently a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
M₁₁ is an alkali metal; and
d, e, f, g, and h are each independently integers of 0 to 2.

10. The separator as claimed in claim 1, wherein:
the inorganic particles comprise at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, and boehmite.

11. The separator as claimed in claim 1, wherein:
a D50 particle size of the inorganic particle is in a range of about 0.1 μm to about 10 μm.

12. The separator as claimed in claim 1, wherein:
a weight ratio of the swellable adhesive binder to the inorganic particles in the heat resistant adhesive layer is in a range of about 1:3 to about 1:30.

13. The separator as claimed in claim 1, wherein:
a weight ratio of the heat resistant binder and the swellable adhesive binder in the heat resistant adhesive layer is in a range of about 1:1 to about 1:10.

14. The separator as claimed in claim 1, further comprising another heat resistant adhesive; wherein:
each heat resistant adhesive layer is located on one of the surfaces of the substrate.

15. The separator as claimed in claim 1, wherein:
a thickness of the heat resistant adhesive layer is in a range of about 0.1 μm to about 5 μm.

16. The separator as claimed in claim 1, wherein:
the substrate comprises a polyolefin-based substrate.

17. The separator as claimed in claim 1, wherein:
a thickness of the substrate is in a range of about 1 μm to about 40 μm.

18. A rechargeable lithium battery, comprising
a positive electrode;
a negative electrode; and
the separator as claimed in claim 1 between the positive electrode and the negative electrode.

19. The rechargeable lithium battery as claimed in claim 18, wherein the separator further comprises another heat resistant adhesive; and wherein
each heat resistant adhesive layer is on one of the surfaces of the substrate, and
a loading amount of the swellable adhesive binder in contact with the negative electrode is higher than a loading amount of the swellable adhesive binder in contact with the positive electrode.
